(19) United States
(12) Patent Application Publication
(10) Pub. No.: US 2021/0261083 A1
(43) Pub. Date: Aug. 26, 2021

(54) VEHICLE SEAT COVER

(71) Applicant: Easepal Enterprises Ltd., Xiamen (CN)

(72) Inventor: Rex Tsai, Xiamen (CN)

(21) Appl. No.: 17/020,736

(22) Filed: Sep. 14, 2020

(30) Foreign Application Priority Data
Feb. 25, 2020 (CN) 202020204403.9

(51) Int. Cl. B60R 21/2165; B60N 2/58; B60R 21/207

(52) U.S. Cl. CPC B60R 21/2165; B60N 2/5883; B60N 2002/5808; B60R 21/207; B60N 2/5891

(57) ABSTRACT

A vehicle seat cover comprises a cushion seat cover and a backrest cover, wherein the backrest cover comprises a front cloth, a back cloth and two side cloths, the side cloth is provided with an airbag blasting seam which is formed by hot pressing.

### FIELD OF THE INVENTION

The present invention relates to a field of seat cover, and more particularly relates to a vehicle seat cover.

### BACKGROUND OF THE INVENTION

To make the interior of the vehicle more attractive, people often put seat covers on the car seats. At present, common sewing locomotive technology is generally used on seat cover sewing. When an accident, such as a traffic accident, happens, cushion seat covers using such sewing technology may wrap the airbag in the seat, which will make the airbag unable to pop up, and fail to play a protective role in time.

As people's safety awareness increases, solutions such as making an opening on a side of the vehicle seat cover occurred. However, some of the vehicles have relatively large airbags, if the opening is relatively small, it is not easy for the airbag to pop out from the opening. Besides, the common airbag openings look unsightly on the seat cover.

Therefore, it is necessary to provide a beautiful and safe car seat cover that does not affect the ejection of the airbag.

### SUMMARY OF THE INVENTION

In order to solve the problem of the prior arts, the present invention provides a vehicle seat cover comprising a cushion seat cover and a backrest cover, wherein the backrest cover comprises a front cloth, a back cloth and two side cloths, the side cloth is provided with an airbag blasting seam which is formed by hot pressing, and the airbag blasting seam is located on the side where the airbag of the vehicle seat pops out.

Preferably, the airbag blasting seam extends along the length direction of the side cloth.

Preferably, the length of the airbag blasting seam is greater than or equal to the maximum blasting diameter of the airbag.

Preferably, the vehicle seat comprises a backrest and a headrest, the backrest cover covers the backrest and headrest, and the airbag blasting seam extends from the top of the side of the backrest to the bottom.

Preferably, the backrest cover is connected to the cushion seat cover.

Preferably, the backrest cover is separated from the cushion seat cover.

Preferably, the side cloth is made of chemical fiber.

Preferably, the side cloth is made of polyester.

The present invention further provides a method of manufacturing a vehicle seat cover comprising the following steps:

cutting a front cloth, a back cloth and two side cloths to be prepared to sew a backrest cover;

hot pressing the position where the airbag of the vehicle seat corresponding to the side cloth to form an airbag blasting seam;

sewing the front cloth, the back cloth and the hot pressed side cloths into a whole to form the backrest cover;

sewing a cushion seat cover; and

connecting the backrest cover to the cushion seat cover.

The vehicle seat cover of the present disclosure comprises a cushion seat cover and a backrest cover, wherein the backrest cover comprises a front cloth, a back cloth and two side cloths, the side cloth is provided with an airbag blasting seam which is formed by hot pressing. By using hot pressing on the side cloth where the airbag of the vehicle seat pops out, the cloth is weakened. When the airbag on the side of the vehicle seat pops out, it can pop out smoothly from the weakened airbag blasting seam to protect the passenger. Meanwhile, as the airbag blasting seam formed by hot pressing does not affect the appearance of the vehicle seat cover, it ensures the beauty of the vehicle seat cover.

### BRIEF DESCRIPTION OF THE DRAWINGS

The following drawings of the present invention are used to understand the invention as a part of it. The drawings show an embodiment and the description of the embodiment, so as to explain the principle of the invention, in which:

FIG. 1 shows the perspective view of the vehicle seat cover of the present invention;

FIG. 2 shows the flow chart of the method of manufacturing a vehicle seat cover of the present invention.

In the figures:

100—vehicle seat cover; 1—backrest cover; 2—cushion seat cover; 11—front cloth; 12—back cloth; 13—side cloth; 10—airbag blasting seam.

### DETAILED DESCRIPTION OF THE EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the size and the relative dimension of layers and areas may be exaggerated for clear. Like numbers refer to like elements throughout.

It should be understood that if a component or a layer is described as “on”, “adjacent to”, “connected to” or “coupled to” another component or layer, it may be directly configured on, adjacent to, connected to or coupled to the other component, or there may be a mediate component or a mediate layer. Rather, if a component or a layer is described as “directly on”, “directly adjacent to”, “directly connected to” or “directly coupled to” another component or layer, mediate component or mediate layer does not exist.

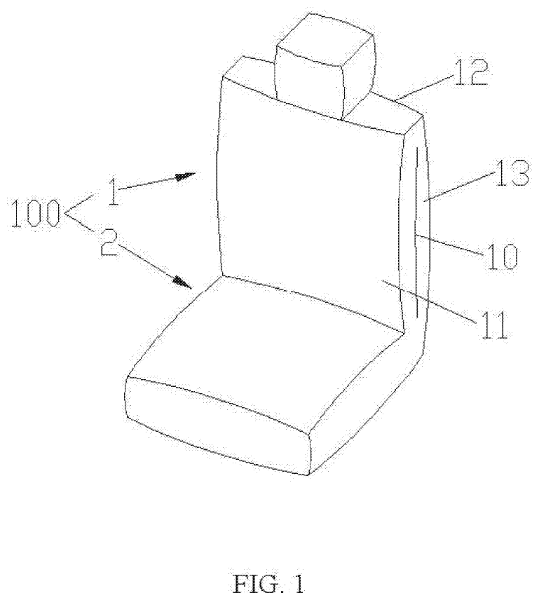

As shown in FIG. 1, the present disclosure provides a vehicle seat cover 100 including a backrest cover 1 and a cushion seat cover 2. The backrest cover 1 includes a front cloth 11, a back cloth 12 and two side cloths 13. The side cloth 13 is provided with an airbag blasting seam 10 which is formed by hot pressing, and the airbag blasting seam 10 is located on the side where the airbag pops out from the vehicle seat.

The airbag blasting seam 10 extends along the length direction of the side cloth 13, and the length of the airbag blasting seam 10 is greater than or equal to the maximum blasting diameter of the airbag. In the embodiment, the vehicle seat includes a backrest and a headrest, the backrest cover 1 covers the backrest and the headrest, and the airbag blasting seam 10 extends from the top of the side of the backrest to the bottom. In other embodiments, the backrest and headrest of the vehicle seat can be separated, the backrest cover 1 only covers the backrest, and the airbag blasting seam 10 extends from the top of the side of the backrest to the bottom.

In the embodiment, the backrest cover 1 is connected to the cushion seat cover 2. It can be understood that in order to match the structure of the vehicle seat, in other embodiments, the backrest cover 1 can also be separated from the cushion seat cover 2.

The side cloth 13 is made of chemical fiber, specifically, the side cloth 13 is made of polyester. In other embodiments, the side cloth can also be made of other cloth, as long as the tearing strength of the cloth after being hot pressed is the same as that of the polyester after being hot pressed.

The vehicle seat cover of the present disclosure includes a cushion seat cover and a backrest cover, wherein the backrest cover includes a front cloth, a back cloth and two side cloths, the side cloth is provided with an airbag blasting seam which is formed by hot pressing. By using hot pressing on the side where the airbag of the vehicle seat pops out, the cloth is weakened. When the airbag on the side of the vehicle seat pops out, it can pop out smoothly from the weakened airbag blasting seam to protect the passenger. Meanwhile, as the airbag blasting seam formed by hot pressing does not affect the appearance of the vehicle seat cover, it ensures the beauty of the vehicle seat cover.

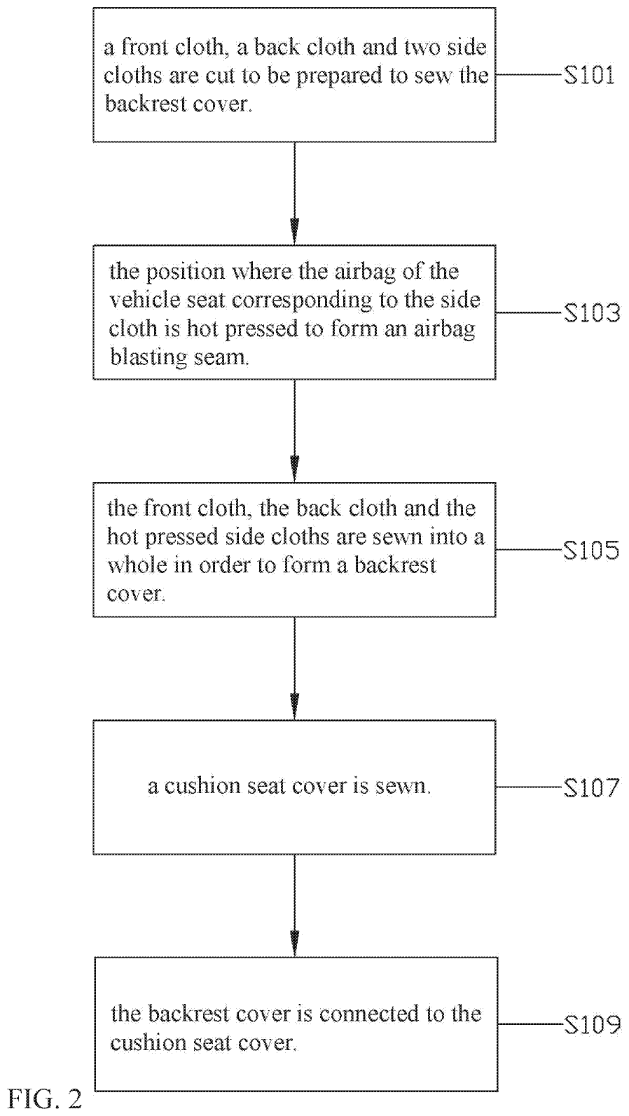

As shown in FIG. 2, a method of manufacturing the vehicle seat cover of the present disclosure includes the following steps:

S101, a front cloth, a back cloth and two side cloths are cut to be prepared to sew the backrest cover. The side cloth is made of chemical fiber, specifically, polyester.

S103, the position where the airbag of the vehicle seat corresponding to the side cloth is hot pressed to form an airbag blasting seam. Specifically, by using a hot pressing equipment, the side cloth is placed in the space with the temperature between 20-30° C. and the humidity not higher than 85%, and the position where the airbag of the vehicle seat corresponding to the side cloth is hot pressed to form an airbag blasting seam. The heating temperature of the hot pressing equipment is constant 180° C., the pressure value is 130 kPa (±3 kpa), and the hot pressing time is between 1.3-1.5 seconds. According to the above settings, the strength of the airbag blasting seam is more suitable for airbag popping, so as to avoid the instability of the airbag blasting seam strength during the manufacturing process, prevent resulting in the failure of airbag popping.

The airbag blasting seam extends along the length direction of the side cloth, and the length of the airbag blasting seam is greater than or equal to the maximum blasting diameter of the airbag. The airbag blasting seam extends from the top of the side of the backrest of the vehicle seat to the bottom.

S105, the front cloth, the back cloth and the hot pressed side cloths are sewn into a whole in order to form a backrest cover.

S107, a cushion seat cover is sewn.

S109, the backrest cover is connected to the cushion seat cover. In this embodiment, the backrest cover is connected to the cushion seat cover, it can be understood that in order to match the structure of the vehicle seat, in other embodiments, the backrest cover can also be separated from the cushion seat cover.

The method of manufacturing the vehicle seat cover of the present disclosure uses hot pressing on the side cloth where the airbag of the vehicle seat pops out, and the cloth is weakened. When the airbag on the side of the vehicle seat pops out, it can pop out smoothly from the weakened airbag blasting seam to protect the passenger. Meanwhile, as the airbag blasting seam formed by hot pressing does not affect the appearance of the cushion seat cover, it ensures the beauty of the cushion seat cover.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A vehicle seat cover comprising a cushion seat cover and a backrest cover, wherein the backrest cover comprises a front cloth, a back cloth and two side cloths, the side cloth is provided with an airbag blasting seam which is formed by hot pressing, and the airbag blasting seam is located on the side where the airbag of the vehicle seat pops out.

2. The vehicle seat cover according to claim 1, wherein the airbag blasting seam extends along the length direction of the side cloth.

3. The vehicle seat cover according to claim 2, wherein the length of the airbag blasting seam is greater than or equal to the maximum blasting diameter of the airbag.

4. The vehicle seat cover according to claim 2, wherein the vehicle seat comprises a backrest and a headrest, the backrest cover covers the backrest and headrest, and the airbag blasting seam extends from the top of the side of the backrest to the bottom.

5. The vehicle seat cover according to claim 1, wherein the backrest cover is connected to the cushion seat cover.

6. The vehicle seat cover according to claim 1, wherein the backrest cover is separated from the cushion seat cover.

7. The vehicle seat cover according to claim 1, wherein the side cloth is made of chemical fiber.

8. The vehicle seat cover according to claim 7, wherein the side cloth is made of polyester.

9. A method of manufacturing a vehicle seat cover comprising the following steps:
cutting a front cloth, a back cloth and two side cloths to be prepared to sew a backrest cover;
hot pressing the position where the airbag of the vehicle seat corresponding to the side cloth to form an airbag blasting seam;
sewing the front cloth, the back cloth and the hot pressed side cloths into a whole to form the backrest cover;
sewing a cushion seat cover; and
connecting the backrest cover to the cushion seat cover.
